(19) United States
(12) Patent Application Publication
(10) Pub. No.: US 2024/0280986 A1
(43) Pub. Date: Aug. 22, 2024

(54) DYNAMIC COLLABORATION AMONG VEHICLES

(71) Applicant: International Business Machines Corporation, Armonk, NY (US)

(72) Inventors: Anujit Rajbangshi, Bangalore (IN); Shailendra Moyal, Pune (IN); Sarbajit K. Rakshit, Kolkata (IN)

(21) Appl. No.: 18/172,373

(22) Filed: Feb. 22, 2023

(51) Int. Cl. G05D 1/00; G05D 1/02; G05D 1/10

(52) U.S. Cl. CPC G05D 1/0088

(57) ABSTRACT

According to one embodiment, a method, computer system, and computer program product for dynamic collaboration among vehicles is provided. The embodiment may include gathering information about one or more situation areas. The embodiment may also include identifying one or more tasks required for each situation area. The embodiment may further include gauging space available in each situation area. The embodiment may also include determining responding entity requirements to complete the one or more tasks in each situation area. The embodiment may further include locating one or more responding entities that are near enough to the one or more situation areas to perform a task from the one or more tasks. The embodiment may also include determining a collaboration plan for the one or more responding entities. The embodiment may further include directing the one or more responding entities according to the collaboration plan.

### BACKGROUND

The present invention relates generally to the field of computing, and more particularly to internet of things (IoT).

IoT is a conception of computer networks as consisting not only of typical computing devices, but also a variety of devices connected to that network. IoT brings together several different technologies to power smart homes, smart cities, and a variety of different businesses. IoT devices may have processors, radios, or sensors, and related capabilities, enabling them to collect data and perform a wide variety of tasks. Moving devices such as vehicles, unmanned aerial vehicles, and robots may be used to move in and engage with the real world according to a plan set by a computational network, or by a human directing many devices at once through a network.

### SUMMARY

According to one embodiment, a method, computer system, and computer program product for dynamic collaboration among vehicles is provided. The embodiment may include gathering information about one or more situation areas. The embodiment may also include identifying one or more tasks required for each situation area. The embodiment may further include gauging space available in each situation area. The embodiment may also include determining responding entity requirements to complete the one or more tasks in each situation area. The embodiment may further include locating one or more responding entities that are near enough to the one or more situation areas to perform a task from the one or more tasks. The embodiment may also include determining a collaboration plan for the one or more responding entities. The embodiment may further include directing the one or more responding entities according to the collaboration plan.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for navigation through real-time street view.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to IoT. The following described exemplary embodiments provide a system, method, and program product to, among other things, provide real-time navigation instructions to users based on context. Therefore, the present embodiment has the capacity to improve the technical field of IoT by allowing vehicles and similar devices to collaborate in real-time, in situations with limited space and urgent needs.

As previously described, IoT is a conception of computer networks as consisting not only of typical computing devices, but also a variety of devices connected to that network. IoT brings together several different technologies to power smart homes, smart cities, and a variety of different businesses. IoT devices may have processors, radios, or sensors, and related capabilities, enabling them to collect data and perform a wide variety of tasks. Moving devices such as vehicles, unmanned aerial vehicles, and robots may be used to move in and engage with the real world according to a plan set by a computational network, or by a human directing many devices at once through a network.

IoT may be used to direct vehicles, unmanned aerial vehicles, robots, and similar devices. However, directing many such devices simultaneously may result in conflicts and inefficiencies, such as several ambulances being sent to the same area at the same time when only one is necessary, or a plow taking up space that should be reserved for a fire truck. As such, it may be advantageous to dynamically direct vehicles to follow a collaborative plan based on need, space available, and other relevant information.

According to one embodiment, a method for dynamic collaboration among vehicles is provided. The method may involve gathering information about and gauging space available in a situation area, such as a construction area or an area affected by a natural disaster. The method may then involve determining what tasks must be performed at the situation area, and what vehicles may be necessary to address those tasks. The method may further involve locating nearby vehicles to perform or assist in performing the tasks. Finally, the method may develop a collaboration plan for vehicles to address the situation, directing the vehicles according to the plan.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

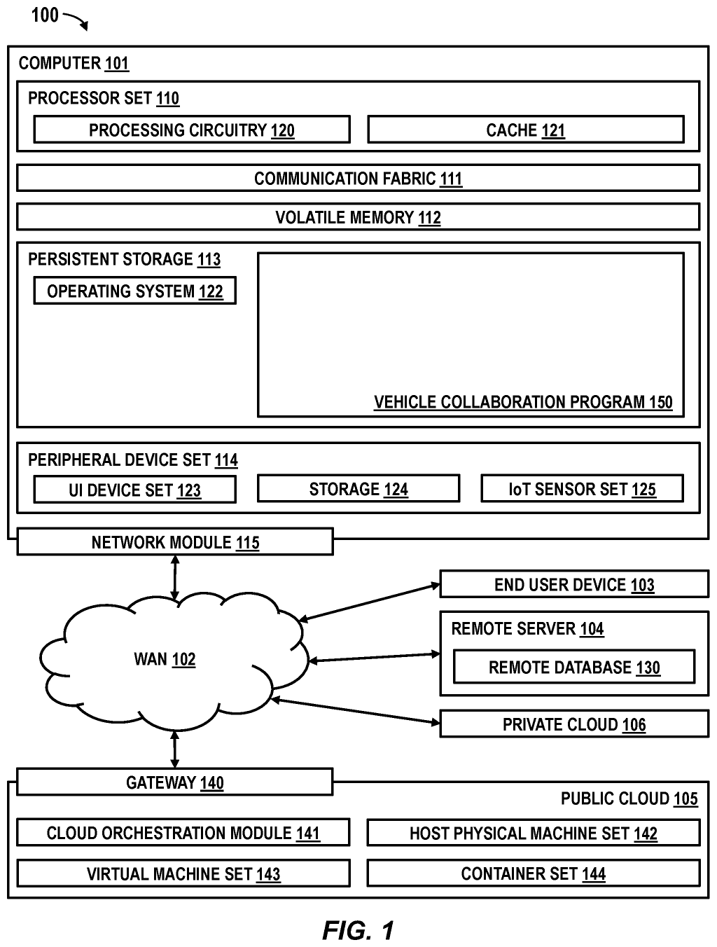

Referring now to FIG. 1, computing environment 100 contains an example of an environment for the execution of at least some of the computer code involved in performing the inventive methods, such as vehicle collaboration program 150. In addition to vehicle collaboration program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and vehicle collaboration program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed conversation is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in vehicle collaboration program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in vehicle collaboration program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The vehicle collaboration program 150 may gather information about and gauging space available in a situation area. A situation may be, for example, a traffic accident or a natural disaster. The situation may call for the performance of certain tasks. The vehicle collaboration program 150 may determine what tasks are necessary, and may then locate nearby vehicles to perform the tasks. The vehicle collaboration program 150 may then determine an optimal collaboration plan, and direct vehicles according to that plan.

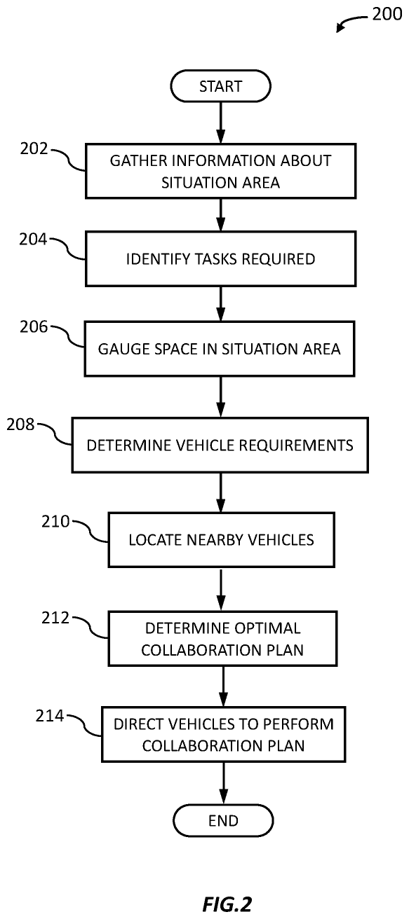

Furthermore, notwithstanding depiction in computer 101, vehicle collaboration program 150 may be stored in and/or executed by, individually or in any combination, end user device 103, remote server 104, public cloud 105, and private cloud 106. The real-time navigation method is explained in more detail below with respect to FIG. 2.

Referring now to FIG. 2, an operational flowchart for a process for contextual collaboration among vehicles process 200 is depicted according to at least one embodiment. At 202, the vehicle collaboration program 150 gathers information about one or more situation areas. A situation area may be, for example, an area around an accident, a natural disaster, a weather event, a violent event, construction, or a traffic event, or a combination or subset of such areas. Information may be gathered using device sensors, such as cameras, microphones, geolocation sensors, compasses, weather sensors, and any other IoT-connected sensors. Information may further be obtained through other means, such as a traffic Application Programming Interface (API), map APIs, and city APIs. Gathering information may include contextual situation analysis.

In at least one embodiment, a situation area may be, for example, an area around a natural disaster, an accident, a fire, or a similar area where a situation might cause widespread damage to people, terrain, buildings, statues, or a combination thereof. Alternatively, a situation may be a predictable event, such as construction, road work, or high foot traffic, that may demand certain types of responding entities, such as construction vehicles or public transportation. As yet another alternative, a situation may be an adverse weather condition, such as flooding, heavy snow, extreme heat, or extremely dry air, such as may have a tendency to exacerbate a wildfire.

A situation may be a combination of the above described situations, and a situation area may contain more than one area corresponding to different issues or conditions. For example, a situation area corresponding to a fire may include one area actively on fire, another area affected by smoke, another area in danger of the spread of fire, another area where ambulances may be useful in helping people affected by the fire, and another area corresponding to the range of fire trucks around the fire that are able to assist with putting out the fire or rescuing people. Such areas may or may not overlap with one another.

An area may be a two-dimensional area on a map, or the three-dimensional area corresponding to that two-dimensional area. Alternatively, an area may be defined more specifically in three dimensions. For example, an area may include an underground cavern but not the land directly above the cavern.

In at least one embodiment, information may be gathered using device sensors, such as cameras, microphones, geolocation sensors, compasses, weather sensors, and any other IoT-connected sensors. Such sensors may be integrated into or communicatively coupled with a device such as a vehicle, unmanned aerial vehicle, robot, mobile phone, laptop, a fixture (e.g., a street lamp, traffic light, or weather sensor), or a peripheral or independent sensor device such as a dashboard camera or a weather sensor.

Information may further be obtained through other means, such as a traffic Application Programming Interface (API), map APIs, weather APIs, and other APIs relevant to the area. APIs may be used to access data collected on private or public servers, or through third party services. As an alternate example, the vehicle collaboration program 150 may gather information from an internet event website to determine that there will be a large amount of foot traffic entering a park from its south entrance at noon the next day.

Gathering information may further include processing other information obtained at 202 or 204 in a process of contextual situation analysis. For example, if a weather forecast suggested light snow, but current weather sensors suggest that changed conditions will lead to an increased snowfall, and that there are currently three snowplows near the area, contextual situation analysis may determine that more snowplows will be required soon.

In another embodiment, the vehicle collaboration program 150 may gather information not relating to a particular situation area. For example, the vehicle collaboration program 150 may gather information about a larger area, such as a county or a large-scale metropolitan area that contains more than one situation area.

Information may be gathered in formats that are easy for computers to parse, such as an API that provides structured weather data; in natural language formats, such as a text-based news report written in natural language, and parsed by natural language processing; in image-or video-based formats that can be parsed by computer vision, such as satellite imagery; in audio formats that can be parsed by such technologies as speech-to-text, such as a radio traffic report; or in any other format in which data might be found.

Information may be gathered dynamically, repeatedly, continuously, substantially continuously (e.g., repeatedly at a high frequency), or in response to any event. For example, the vehicle collaboration program 150 may listen to events from a city's municipal API service announcing road closures.

Then, at 204, the vehicle collaboration program 150 identifies one or more tasks to be performed at the situation area. Tasks may be responsive to the needs of the situation, and may be determined based on gathered information, contextual situation analysis, historical data, or machine learning. Identifying tasks may include identifying a type of task, how many instances of a task may be required, how much space the task takes up, an order in which tasks are to be performed, priority for a task, or the amount of time or a measure of resources required to perform a task.

In at least one embodiment, tasks may be determined based on gathered information. For example, if gathered information indicates that there is a fire in the situation area, one task may be to put out a fire. If gathered information also indicates that there are people in the situation area near the fire, another task may be to treat people who need treatment. If gathered information indicates, more specifically, that nine people have burns and have inhaled smoke, five people only have burns, six people have only inhaled smoke, a task may be to treat that number of people with those specific issues.

Alternatively, tasks may be determined based on contextual situation analysis. For example, if a situation requires a large number of ambulances, but much of the situation area is blocked by rubble, debris, impassable earth, or other obstructions, one task may be to clear the debris to make room for more responding entities.

Tasks may also be determined based on historical data. For example, if historical data indicates that fires of similar size to a current fire in a similar building to the current building ultimately result in about 14-34 people requiring treatment, one task may be to treat 14-34 people.

Tasks may also be determined by a process of artificial intelligence (AI). AI may be performed based on gathered information, historical data, space available, or any other useful information. AI may include machine learning, artificial neural networks, and other similar techniques.

Identifying tasks may include identifying a type of task, how many instances of a task may be required, how much space the task takes up, an order in which tasks are to be performed, priority for a task, or the amount of time or a measure of resources required to perform a task. Determining a priority for a task may include, for example, determining, through a process of contextual situation analysis using machine learning methods and medical triage techniques, a priority order or priority rating for treating various injuries. Priority may compare like tasks (such as comparing multiple injuries) or unlike tasks (such as comparing the urgency of clearing debris to make room for more responding entities to the urgency of putting out a fire). Priority may be determined relatively compared to other tasks in the area, other tasks historically identified by the vehicle collaboration program 150, or other tasks among any number of situation areas.

Determining a measure of resources required to perform a task may include measuring a specific resource, such as time needed, space needed, or water needed, or measuring an overall measure of resources that may be consumed by a task. An overall measure may be represented, for example, by a cost in dollars, by an abstract rating of resource consumption such as on a 1-10 scale or a graduated visual scale, or by list or array of different costs. For example, if an earthquake has damaged a building, underground pipes, and a major road, and the vehicle collaboration program 150 determines that repairing each of these problems is a distinct task, the vehicle collaboration program 150 may determine an approximate dollar value for each of these repairs.

Tasks may be one-time tasks such as “put out that fire,” or “treat twelve patients,” continuous tasks such as “keep this road clear,” or “treat at least eight patients per hour,” or standby tasks such as “be available to treat any injured patients.”

Tasks may be assigned and reassigned dynamically, repeatedly, continuously, substantially continuously (such as once per second), or in response to any change in any other factor. For example, if a fire spreads from one building to a nearby building, the vehicle collaboration program 150 may assign a new task to put out the new fire.

Next, at 206, the vehicle collaboration program 150 gauges space available in the situation area. Gauging space may include measuring the geometric area or space of the situation area with specific dimensions, the usable space, the flat space, the space that can be accessed by particular types of responding entities, or a number of responding entities that may fit. Space may be gauged based on gathered information, historical data, or a process of AI.

Gauging space may include measuring a geometric area as it appears on a map, or as calculated at multiple levels. For example, an underground area and an above ground area corresponding to the same part of a map may be counted as two areas if they both provide usable space. Usable space may be determined based on the topology of the space, where flat space is more usable and irregular surface is less usable. Alternatively, usable space may be determined based on specific responding entity requirements. For example, ambulance-usable space may be defined as space with a certain topology that can be accessed by a wheeled vehicle, whereas space usable by unmanned aerial vehicles may be defined as all the space in an area, presuming all of the space in the area can be accessed by unmanned aerial vehicles.

Furthermore, gauging usable space may be a complex abstract representation of the topology of the area. For example, a specific shape of a flat area next to a specific shape of an irregular surface may be conducive to parking an ambulance in a way that patients may be treated on irregular space near the ambulance.

Gauging space may include measuring a number of responding entities or specific combination of responding entities that can fit. Maximizing a combination of responding entities that may fit may be performed using methods similar to those commonly used, for example, for a knapsack problem, or similar algorithmic problem, using such techniques as weighted graphs, an exhaustive search, AI, greedy algorithms, or approximation algorithms.

Space may be gauged based on gathered information, historical data, or a process of AI, including use of machine learning or neural networks.

Space may be gauged dynamically, repeatedly, continuously, substantially continuously (e.g., once per second), or in response to any event that may change the space available in the area. For example, if a task requires clearing debris, space may be gauged when the responding entity assigned to clear the debris reports completion. Alternatively, if a situation is a series of earthquakes, space may be gauged after each earthquake.

Then, at 208, the vehicle collaboration program 150 determines responding entity requirements in the situation area given the tasks required and the space available. A responding entity may be a vehicle, including land vehicles, helicopters, airplanes, and boats; a robot; an unmanned aerial vehicle; or, alternatively, any other unit that may perform or assist with required tasks and that is connected to the vehicle collaboration program 150 by a network. Responding entity requirements may include a number or type of responding entity required, or a specific list of the responding entities required.

In at least one embodiment, a responding entity may be a vehicle. A vehicle may include a land, sea, or air vehicle. Land vehicles may include ambulances, fire trucks, pickup trucks, bulldozers, cranes, tow trucks, snow plows, or other emergency vehicles, construction vehicles, or similar. Vehicles may further include helicopters, airplanes, boats, and submarines. Vehicles may further any vehicle capable of delivering or transporting helpful goods or people, or helping move people to a safer or less crowded area. A vehicle may include a passenger vehicle, a single-rider vehicle such as a motorcycle or bicycle, or an unmanned vehicle such as a self-driving bulldozer.

Alternatively, responding entities may include robots or unmanned aerial vehicles. Robots may include helper robots such as Spot® (Spot and all Spot-based trademarks and logos are trademarks or registered trademarks of Boston Dynamics, Inc. and/or its affiliates).

In an alternate embodiment, a responding entity may include any unit directed by a network-connected device. For example, a responding entity may include a paramedic using a phone and riding a bike, or a group of first responders on foot led by a first responder using a specialized first responder device.

Responding entities may be defined generally (e.g., “ambulances”) or at any level of specificity (e.g., “large ambulance, small ambulance” or “ambulance model A, ambulance model B”). Responding entity requirements may even refer to specific responding entities located or identified at 210.

Responding entities may be defined, in part, by capabilities, or by tasks a responding entity can perform. For example, fire truck model A may be defined as having a hose for fighting fires if a hydrant is available, a 24-foot ladder, 3-8 firefighters, and other assorted tools.

In at least one embodiment, responding entity requirements may be a list of responding entities or responding entity types required. Alternatively, responding entity requirements may be an abstract measure, such as a point system. For example, if a task is to clear a certain amount of debris, a responding entity requirement may be 8 points of debris-clearing vehicles, where bulldozer A is worth 5 points, bulldozer B is worth 4 points, and crane A is worth 3 points.

In another embodiment, the vehicle collaboration program 150 may create more than one alternative list of responding entity requirements. For example, three alternative lists of responding entity requirements may be: two large fire trucks; one large fire truck and two small fire trucks; one large fire truck, one medium fire truck, and one small fire truck. The vehicle collaboration program 150 may select among these alternatives dynamically, for example as part of a collaboration plan determined at 212 or based on nearby responding entities as determined at 210.

Responding entity requirements may be determined and redetermined dynamically, repeatedly, continuously, substantially continuously (repeatedly, at a high frequency), or in response to any event. For example, if new debris falls into the flat part of an area that is needed for an ambulance, a requirement for a vehicle that can clear that debris quickly may be added or given increased priority, prioritized, for example, immediately above the priority of the ambulance itself.

Next, at 210 the vehicle collaboration program 150 locates nearby responding entities. Locating may include identifying a location, for example through geolocation or similar techniques, or measuring a physical distance from or time needed to reach the situation area or a specific position in the situation area. Locating responding entities may also include identifying responding entities.

Identifying responding entities may include identifying a type of responding entity as described at 208. Identifying responding entities may further include specific details about a particular responding entity, such as the number of passengers, professional qualifications of passengers, equipment and supplies on hand, fuel or battery power available, and condition in general. Information about a responding entity may be modeled as a digital twin.

Responding entities may be stored in a storage location such as a parking lot or warehouse, or may be out in the real world, such as trucks on a road or unmanned aerial vehicles in the air.

Nearby responding entities may be located dynamically, repeatedly, continuously, substantially continuously (e.g., located once every second), or in response to any event that may suggest new responding entities may be found.

Then, at 212 the vehicle collaboration program 150 determines an optimal collaboration plan. A collaboration plan may determine a target area or more specific target position for one or more responding entities, a role for the responding entities, a route for the responding entities, any more specific instructions, and timing for instructions. An optimal plan may be the plan that best protects human life, the plan that bet protects the value of property in cases that are not a risk to human life, a cost-efficient plan, or a time-efficient plan dedicated to placing the necessary responding entities quickly, a plan that optimizes some weighted combination of these factors, or a plan that makes a quick approximate determination of optimization. Determining a collaboration plan may be performed using optimization algorithms, approximation algorithms, AI, contextual situation analysis, or a combination of these approaches. A collaboration plan may be formed based on any combination of responding entity requirements, required tasks, responding entity locations, gathered data, traffic data, historical data.

A collaboration plan may determine a target area or more specific target position for one or more responding entities, or a route for the responding entities to take to get to the area or position. A target position may include a specific location, a direction in which the responding entity is supposed to face, or an area for a responding entity to set up, such as a food distribution truck setting up a seating area or an unmanned aerial vehicle dropping off supplies in a particular location. A collaboration plan may determine which set of responding entity requirements from several alternative sets of responding entity requirements should be used.

A collaboration plan may also determine a role for a responding entity. For example, a collaboration plan may assign a fire truck to serve the role of a mobile ladder if that role is more urgent than putting out a small fie in a different location. As another example, an ambulance may be assigned to a standby role, and may be positioned between different situation areas or potential situation areas to fill a more active role as the need arises.

A collaboration plan may determine any more specific instructions, and timing for instructions. For example, a collaboration plan may instruct an unmanned aerial vehicle to hover above an area, wait for a specific time, and drop medical supplies at that specific time. Alternatively, a collaboration plan may instruct a law enforcement vehicle to go to a specific point, wait for rubble to be cleared by other responding entities, wait for an ambulance to leave the area, through the path the rubble was cleared from, and then proceed to a target position.

A collaboration plan may be determined using various forms of data, responding entity requirements, required tasks, responding entity locations, gathered data, traffic data, historical data. A collaboration plan may be determined using optimization algorithms, approximation algorithms, greedy algorithms, AI, contextual situation analysis, or a combination of these approaches. An approximation algorithm may be used, for example, for efficient, fast “triage” of large-scale areas, such as a large metropolitan area, containing multiple situation areas. Alternatively, a greedy algorithm may select three different collaboration plans determined by a process of AI, make small changes to each plan, and project the expected value of each small change. The greedy algorithm may integrate positive changes and reject negative changes, Once no positive changes can be found to any of the three collaboration plans processed in this way, the plan with the highest expected value may be selected as optimal.

An optimal plan may be the plan that best protects human life, the plan that bet protects the value of property in cases that are not a risk to human life, a cost-efficient plan, or a time-efficient plan dedicated to placing the necessary responding entities quickly, a plan that optimizes some weighted combination of these factors, or a plan that makes a quick approximate determination of optimization. For example, if an earthquake has damaged a building, underground pipes, and a major road, and the vehicle collaboration program 150 may determine an approximate dollar value for each of these repairs, a dollar cost for each of the repairs, a time estimation for each of the repairs, an opportunity cost for each repair compared to the next most efficient task an occupied responding entity or resource might perform, a graph of the cost of delaying such repairs over time, and risks relating to potential future earthquakes. The vehicle collaboration program 150 may then combine all of these factors into overall expected values for a large number of alternative collaboration plans, and select the collaboration plan with the highest overall expected value.

A collaboration plan may be determined or modified dynamically, repeatedly, continuously, substantially continuously (e.g., updated once every second), or in response to any event change in any of the above factors.

Next, at 214 the vehicle collaboration program 150 dynamically directs responding entities to perform the collaboration plan. Directing may include setting a destination, setting a path, rerouting, sending a message or notification, sending directions, or directing a self-driving vehicle. A message or notification may be sent to a driver, pilot, or operator of a vehicle.

A responding entity may be directed to stay still, or to follow instructions from a collaboration plan at a particular time or in a particular manner, as discussed at 212. A responding entity may be directed within or without a situation area. For example, an unmanned aerial vehicle may be directed to fly around in circles in a city, periodically approaching different situation areas or potential situation areas, waiting for an urgent situation.

Responding entities may be directed or redirected dynamically, repeatedly, continuously, substantially continuously (repeatedly at very frequent intervals), or in response to any event change in any of the above factors, such as a change in the collaboration plan.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
gathering information about one or more situation areas;
identifying one or more tasks required for each situation area in the one or more situation areas;
gauging space available in each situation area in the one or more situation areas;
determining responding entity requirements to complete the one or more tasks in each situation area in the one or more situation areas;
locating one or more responding entities that are near enough to the one or more situation areas to perform a task from the one or more tasks;
determining a collaboration plan for the one or more responding entities; and
directing the one or more responding entities according to the collaboration plan.

2. The method of claim 1, wherein the one or more responding entities are selected from the group consisting of vehicles, robots, and unmanned aerial vehicles.

3. The method of claim 1, wherein the collaboration plan is optimized to minimize risk to human life.

4. The method of claim 1, wherein the gathering information is performed with regards to two or more situation areas in a greater area.

5. The method of claim 1, wherein the collaboration plan is redetermined or modified after being determined in response to a piece of newly gathered information.

6. The method of claim 1, wherein the locating one or more responding entities further comprises locating two or more responding entities, and further comprising:
identifying one task from the one or more tasks as a task to move debris, earth, or other obstructions to create a clear area usable by other responding entities from the two or more responding entities.

7. The method of claim 1, wherein tasks required are identified using a process of artificial intelligence and machine learning.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
gathering information about one or more situation areas;
identifying one or more tasks required for each situation area in the one or more situation areas;
gauging space available in each situation area in the one or more situation areas;
determining responding entity requirements to complete the one or more tasks in each situation area in the one or more situation areas;
locating one or more responding entities that are near enough to the one or more situation areas to perform a task from the one or more tasks;
determining a collaboration plan for the one or more responding entities; and
directing the one or more responding entities according to the collaboration plan.

9. The computer system of claim 8, wherein the one or more responding entities are selected from the group consisting of vehicles, robots, and unmanned aerial vehicles.

10. The computer system of claim 8, wherein the collaboration plan is optimized to minimize risk to human life.

11. The computer system of claim 8, wherein the gathering information is performed with regards to two or more situation areas in a greater area.

12. The computer system of claim 8, wherein the collaboration plan is redetermined or modified after being determined in response to a piece of newly gathered information.

13. The computer system of claim 8, wherein the locating one or more responding entities further comprises locating two or more responding entities, and further comprising:
identifying one task from the one or more tasks as a task to move debris, earth, or other obstructions to create a clear area usable by other responding entities from the two or more responding entities.

14. The computer system of claim 8, wherein tasks required are identified using a process of artificial intelligence and machine learning.

15. A computer program product, the computer program product comprising:
one or more computer-readable tangible storage medium and program instructions stored on at least one of the one or more tangible storage medium, the program instructions executable by a processor capable of performing a method, the method comprising:
gathering information about one or more situation areas;
identifying one or more tasks required for each situation area in the one or more situation areas;
gauging space available in each situation area in the one or more situation areas;
determining responding entity requirements to complete the one or more tasks in each situation area in the one or more situation areas;
locating one or more responding entities that are near enough to the one or more situation areas to perform a task from the one or more tasks;
determining a collaboration plan for the one or more responding entities; and
directing the one or more responding entities according to the collaboration plan.

16. The computer program product of claim 15, wherein the one or more responding entities are selected from the group consisting of vehicles, robots, and unmanned aerial vehicles.

17. The computer program product of claim 15, wherein the collaboration plan is optimized to minimize risk to human life.

18. The computer program product of claim 15, wherein the gathering information is performed with regards to two or more situation areas in a greater area.

19. The computer program product of claim 15, wherein the collaboration plan is redetermined or modified after being determined in response to a piece of newly gathered information.

20. The computer program product of claim 15, wherein the locating one or more responding entities further comprises locating two or more responding entities, and further comprising:
identifying one task from the one or more tasks as a task to move debris, earth, or other obstructions to create a clear area usable by other responding entities from the two or more responding entities.
